(19) United States
(12) Patent Application Publication
(10) Pub. No.: US 2009/0006337 A1
(43) Pub. Date: Jan. 1, 2009

(54) METHOD AND APPARATUS FOR AUTOMATIC DETECTION AND IDENTIFICATION OF UNIDENTIFIED VIDEO SIGNALS

(75) Inventor: Kwan Cheung, Bryn Mawr, PA (US)

Correspondence Address: TED SABETY, c/o Sabety +associates, PLLC, 1130 Bedford Rd., PLEASANTVILLE, NY, 10570, US

(73) Assignee: MEDIAGUIDE, INC., Berwyn, PA (US)

(21) Appl. No.: 12/037,876

(22) Filed: Feb. 26, 2008

Related U.S. Application Data
(63) Continuation-in-part of application No. 10/598,283, filed on Aug. 23, 2006.
Application No. 10/598,283 is a continuation-in-part of application No. 11/322,706, filed on Dec. 30, 2005.
Application No. 11/322,706 is a continuation-in-part of application No. PCT/US06/62079, filed on Dec. 14, 2006.
Application No. PCT/US06/62079 is a continuation-in-part of application No. PCT/US06/60891, filed on Nov. 14, 2006.
(60) Provisional application No. 60/891,548, filed on Feb. 26, 2007.

(51) Int. Cl. G06F 17/30; H04N 7/173

(52) U.S. Cl. 707/3; 725/110

(57) ABSTRACT

A method of detecting the identity of video programming is described, whereby known video programming is converted into a set of pattern vectors stored in a database and incoming detected video programming is converted into a set of pattern vectors that are used to search the database for matching pattern vectors indicating a match with the known video programming.

This application claims priority to U.S. patent application Ser. No. 10/598,283, filed on Aug. 26, 2006, which is incorporated herein by reference in its entirety.

This application claims priority to U.S. patent application Ser. No. 11/322,706, filed Dec. 30, 2005, is incorporated herein by reference in its entirety.

This application claims priority to PCT/US06/62079, filed on Dec. 14, 2006 which is incorporated herein by reference in its entirety.

This application claims priority to PCT/US2006/060891, filed on Nov. 14, 2006, which is incorporated herein by reference in its entirety.

This application claims priority to U.S. Provisional Application No. 60891548, filed on Feb. 26, 2007, which is incorporated herein by reference in its entirety.

### BACKGROUND AND SUMMARY OF THE INVENTION

This invention relates to the automatic detection and identification of broadcast programming, for example television signals and digital video whether broadcast or downloaded as analog, digital or digital over the Internet. By “Broadcast” it is meant any readily available source of content, whether now known or hereafter devised, including, for example, streaming, peer to peer delivery of downloads, other delivery of downloads or detection of network traffic comprising such content delivery activity. The system initially registers a known video program, which consists of a sequence of image frames, by digitally sampling the program in segments, typically on a frame by frame basis, and extracting particular feature sets that are characteristic of the frame. The frame here can be the entire image frame, or a defined region within the image frame of the sequence. The invention processes each set of features to produce a numerical code that represents the feature set for a particular segment or frame of the known program. These codes and the registration data identifying the program populate a database as part of the system. Once registration of one or more programs is complete, the system can then detect and identify the presence of the registered programming in a broadcast signal or its presence in and among a set of video signals (whether stored or broadcast) by extracting a feature set from the input signal, producing a numerical code for each segment input into the system and then comparing the sequence of detected numerical codes against the numerical codes stored in the database corresponding to known video content. Various testing criteria are applied during the comparison process in order to reduce the rate of false positives, false negatives and increase correct detections of the registered programming. The invention also encompasses certain improvements and optimizations in the comparison process so that it executes in a relatively short period of time.

The present invention relates to a method of detecting and tracking unknown broadcast video content items that are periodically encountered by automatic detection and tracking systems. It is known in the art that detection of broadcast content, for example, music broadcast over radio, includes the sampling the of the identified content to compute numerical representations of features of the content, sometimes referred to in the art as a fingerprint, or in the related patent application PCT/US05/04802, filed on Feb. 16, 2004, (the national stage in the U.S. is U.S. patent application Ser. No. 10/598,283, filed Aug. 26, 2006) which is incorporated herein by reference, a pattern vector. These known pattern vectors are stored in a database and while the broadcast signals are received, the same computation is applied to the incoming signal. Then, the detection process entails searching for matches between the incoming computed pattern vectors and the vast database of pre-created pattern vectors associated with the identity of known content.

Pattern vectors, also referred to herein as fingerprints, may also be derived from video frames by means of the application of digital signal processing or other algebraic techniques. The fingerprint of a section of video is one or more numbers that are derived from the numbers making up the images comprising the section of the video. Typically, one or more fingerprints may be calculated from a frame of video. Fingerprints may be calculated on a frame by frame basis or one frame out of a predetermined number of frames.

The techniques of searching through a database of pattern vectors looking for a series of matches may be used for pattern vectors derived from video. The basic principles are the same as with searching for audio, albeit with some adaptations to accommodate the operating parameters associated with video signals. The pattern vector itself may be derived in the manner set forth herein. In addition, the management of distributed databases of pattern vectors for searching for analyzing many broadcast signals in distinct geographic areas can be applied using the video pattern vectors, In addition, it is possible to mark repeated video sequences that are unknown and then note repeated unknown similar sequences for later identification, or harvesting, using matching techniques and the detection of self similarities among sequences of frames. Practitioners of ordinary skill will recognize that the system can be adapted to visit websites on the Internet and download or otherwise receive video programming data from the website and automatically determine the identity of the programming available at the selected URL whose activation resulted in the download or delivery of the video program.

### PRIOR ART

A number of methods have been developed to automate the detection of broadcast programming. These techniques generally fall into one of two categories: cue detection or pattern recognition. The cue detection method is exemplified by U.S. Pat. Nos. 4,225,967 to Miwa et. al.; 3,845,391 to Crosby and 4,547,804 to Greenberg. These techniques rely on embedded cues inserted into the program prior to distribution. These approaches have not been favored in the field. In audio, the placement of cue signals in the program have limited the acceptance of this approach because it requires the cooperation of the program owners and/or broadcasters—thus making it impractical.

The pattern recognition method generally relies on the spectral or other characteristics of the content itself to produce a unique identifying code or signature. Thus, the technique of identifying content consists of two steps: the first being extracting a signature or fingerprint from a known piece of content for insertion into a database, and the second being extracting a signature or fingerprint from a detected piece of content and searching for a signature or fingerprint match in the database in order to identify the detected content. In this way, the preferred approach relies on characteristics of the broadcast content itself to create a signature unique to that content. For example, U.S. Pat. No. 4,739,398 to Thomas, et. al. discloses a system that takes a known television program and creates for each video frame, a signature code out of both the audio and the video signal within that frame. More recently, similar detection systems have been proposed for Internet distributed content, for example application PCT WO 01/62004 A2, filed by Ikeyoze et. al. U.S. Pat. Nos. 5,436,653 to Ellis, et. al. and 5,612,729 to Ellis, et. al., disclose a more complex way of calculating a unique signature, where the audio signature corresponding to a given video frame is derived by comparing the change in energy in each of a predetermined number of frequency bands between the given video frame and the same measurement made in a prior video frame. However, the matching technique relies on a combination of the audio and video signatures or the use of a natural marker, in this case, the start or ending of a program.

Y. H. Pao, 1989, Adaptive Pattern Recognition and Neural Networks, Addison Wesley, Reading Ma., is incorporated herein by reference for all that it teaches.

Ronald. N. Bracewell, Fourier Analysis and Imaging, Springer, 2003, ISBN 0306481871, p. 493., is incorporated herein by reference for all that it teaches.

Richard J. Gardner, Geometric Tomography, Cambridge University Press, 1995, ISBN 0521866804, pg. 53. is incorporated herein by reference for all that it teaches.

R. Gonzalez and R. Woods Digital Image Processing, Addison-Wesley Publishing Company, 1992, Chap. 4 is incorporated herein by reference for all that it teaches.

### BRIEF DESCRIPTION OF THE DRAWINGS

FIG. 1: The components of the media broadcast monitoring system.

FIG. 2: Wide format and normal format frames

FIG. 3: The schematic of the DBS operation flow.

FIG. 4: Schematic of Image Rotation Pre Processing

FIG. 5: Schematic of Image Thresholding Dark Border Removal

FIG. 6: Schematic of relation between registered and detected inter-frame distance.

### DETAILED DESCRIPTION OF THE PREFERRED EMBODIMENTS

### A. Overview

The broadcast monitoring and detection system embodying the invention works in two phases: registration and detection. During the registration phase, known programming content is registered with the system by sending the program, as digital data, into the system. A series of signatures, in the case here, a pattern vector also referred to as a “fingerprint” or “signature”, are stored as a sequence of data records in a database, with the identity of the program content cross-referenced to them as a group. During the second phase, unidentified programming is input into the system. Such programming can include video programming, whether terrestrial broadcast, satellite, internet, cable television or any other medium of delivery, whether now known or devised in the future. While such programming is being monitored, the pattern vectors of the programming (or any other signature generating technique) are continually calculated. The calculated pattern vectors are then used to search for a match in the database. When a match is found and confirmed, the system uses the cross-referenced identity in the database to provide the identity of the content that is currently being played or made available for download. In the preferred embodiment, the system is software running on a computer, however, it is envisioned that special purpose hardware components may replace parts or all of each module in order to increase performance and capacity of the system.

In the preferred embodiment, a computer containing a central processing unit is connected to a video digitizing card or interface device into which video programming is presented. For digitally delivered video, the interface is simply a network card that receives the appropriate digital video format, for example, broadcast HD, HDMI, DVI or even video data delivered as streamed or downloaded MPEG-2 or MPEG-4 data delivered through a computer network, including the Internet, that is attached to the computer. During the registration phase, the CPU fetches the video data from the interface card, or from the network card, calculates the pattern vector data, and then, along with timing data and the identity of the program, these results are stored in a database, as further described below. Alternatively, the data may be loaded directly from authentic material, such as DVD disks, HD-DVD disks, Blu-ray discs, or storage devices containing digital data files in MPEG-2, MPEG-4 or any other video data format embodying the video signal. Of course, for some material which may not have a readily available source, then the audio or other program signal is used in the following manner. If the system periodically detects an unknown program but with the substantially the same sequence of signatures each time, it assigns an arbitrary identifier for the sequence as an identifier for the unknown program material and enters the data into the database as if the program had been introduced during the registration phase. Once the program identity is determined in the future, then the database can be updated to include the appropriate content identity information as with authentic information while at the same time providing the owner of the programming the use data detected even when the identity of the program was not yet known. The database, which is typically a data file stored on a hard drive connected to the central processing unit of the computer by means of any kind of computer bus or data transmission interface, including SCSI or Ethernet.

During the detection phase, the CPU fetches the video program data from the video card or the network card, or loads it from a data file that may be stored on the computer hard drive or external media reader. The CPU calculates the pattern vector data for the detected signal, and then, along with the timing data, submits database queries to the database stored on the hard drive. The database may be the same hard drive as in the computer, or an external hard drive accessed over a digital computer network. When matching pattern vector data is found, the CPU continues to process the data to confirm the identification of the programming, as described further below. The CPU can then communicate over any of a wide variety of computer networking systems well known in the art to deliver the identification result to a remote location to be displayed on a screen using a graphical user interface, or to be logged in another data file stored on the hard drive. The program that executes the method may be stored on any kind of computer readable media, for example, a hard drive, CD-ROM, EEPROM or floppy and loaded into computer memory at run-time. In the case of video, the signal can be acquired using an analog to digital video converter card, or the digital video data can be directly detected from digital video sources, for example, the Internet or digital television broadcast.

The system consists of four components. FIG. 1 shows the interconnection of the four modules: (1) a signal processing stage at the front end, (2) a pattern generation module in the middle, (3) followed by a database search engine module, and (4) a program recognition module at the end. During the registration phase, the results of the pattern generation module, which creates signatures for known audio or video content, are stored in the database and the search and pattern recognition modules are not used.

The function of each module is described in further detail below:

### 1. Signal Acquisition (SA) Module

The SA module, (1), receives video data makes it available to the remaining modules. Practitioners of ordinary skill will recognize that there are a variety of products that receive analog video and convert those signals into digital data or to receive digital video or digital files embodying digital video signals. These devices can be any source of digital audio data, including an interface card in a personal computer that converts analog video into digital video data accessible by the computer's CPU, a stand alone device that outputs digital video data in a standard format or a digital video receiver with digital video output. Alternatively, pre-detected signal in digital form, that is, digital video files in a pre-determined format, can be accessed from storage devices connected to the system over typical data networks. Formats like MPEG-2 or MPEG-4 are well known in the art. The SA module regularly or on command reads the data from the digital interface device or data storage and stores the data into a data buffer or memory to be accessed by the Pattern Generation module. Practitioners of ordinary skill will recognize that the typical digital video system will provide a frame's worth of digital video at regular intervals, called the frame rate. The sequence of frames representing the video are stored in sequence. Alternatively, data structures, stored in the computer memory (which includes the hard drive if the operating system supports paging and swapping), may be used where the time frames are not physically stored in sequence, but logically may be referenced or indexed in the sequence that they were detected by means of memory addressing.

### 2. Pattern Vector Generation (PG) Module

The PG module operating during the detection phase, (2), fetches the stored video samples that were detected and stored by the SA Module. Once a frame of the samples is received, the PG module will compute the pattern vector of the frame and, when in detection phase, send the pattern vector to the Database Search Module in the form of a database query. During the registration phase, the PG module calculates the pattern vector in order that it be stored in the database, in correlation with the other relevant information about the known video program. The calculation of the pattern vector is described further below.

Another embodiment for constructing video pattern vectors is described as follows.

A video stream can be viewed as a sequence of 2-dimensional image files. So, a video stream by itself has a well-defined frame structure. The same video stream may be processed, or coded, to the same video sequences but with different configurations. A DVD video sequence in NTSC format has a resolution of 720×480 and frame rate of 29.97 fps can be coded into a VCD video sequence of 320×240 and 29.97 fps. Today's video coders can code this DVD sequence to the same video sequences of arbitrary resolution and arbitrary frame rates.

The requirements of a video fingerprinting detection system requires:
1. Fingerprint of a video frame is robust to arbitrary resolution (i.e. aspect ratio).
2. Fingerprint of a video frame is robust to the luminance, tint, and hue on every frame.
3. Fingerprint of a video frame is robust to the noise on every frame.
4. Identification of a video sequence is robust to different frame rate of the video sequence.

Due to the existence of many formats that a raw video sequence can be mapped onto, the production system SA Module is required to recognize all the popular formats. In the preferred embodiment an open-source codec—MPLAYER and the MENCODER—is used to decode video sequences from many different formats.

### Video Fingerprint or Pattern Vector Formulation

A digital video sequence is a sequence of two-dimensional digital images. Each image is referred to as a frame of the sequence. A frame is composed of a rectangular array of pixels. The resolution of the video sequence is specified in terms of the horizontal (h) and the vertical (v) count of pixels on a frame. For example, a DVD video sequence in NTSC format has a resolution of 720 (h)×480 (v).

The next discussion is about the color space. Each pixel of a frame is a color pixel, composed from three primary colors (Red, Green and Blue, or RGB). The magnitude of each color component is coded into a number of bits. The most popular one is 8 bits but high quality video sequence can have a higher bit count. To map a color digital image to a monochrome (black & white), one simply adds the three primary color values together, and normalizes for the maximum range permitted in the digital output. Given a digital color image where the pixel value at the coordinate (mᵥ,mₕ) is equal to

x_{rgb}(mᵥ,mₕ)={xᵣ(mᵥ,mₕ),x_{b}(mᵥ,mₕ),x_{g}(mᵥ,mₕ)},

where
0≦xᵣ(mᵥ,mₕ)≦1,
0≦x_{b}(mᵥ,mₕ)≦1,
0≦x_{g}(mᵥ,mₕ)≦1,
   are the values of the red, blue and green components respectively.

In the preferred embodiment, the formulation of the video fingerprint formulation is based on RGB color space. Practitioners of ordinary skill will recognize that the calculations used for creating the fingerprint themselves can be transformed into the YUV space, or any other color space, and then applied to video signals encoded in that space, with equivalent results. The fingerprints are derived from any monochromatic representation of the video frames.

Mapping a Frame onto Fingerprint

Given a video sequence:

X={(xᵣ⁽ⁿ⁾(mᵥ,mₕ),x_{g}⁽ⁿ⁾(mᵥ,mₕ),x_{b}⁽ⁿ⁾(mᵥ,mₕ)); n=0, 1, . . . , N−1; mₕ=0, 1, . . . , Mₕ−1; mᵥ=0, 1, . . . , Mᵥ−

where n is the frame index, The following steps are taken to map the k-th frame {(xᵣ^{(k)}(mᵥ,mₕ),x_{g}^{(k)}(mᵥ,mₕ),x_{b}^{(k)}(mᵥ,mₕ)), mₕ=0, 1, . . . , Mₕ−1; mᵥ=0, 1, . . . , Mᵥ−1} to the corresponding fingerprint:

1. Convert the each RGB color pixel to the monochrome pixel.

$${x}_{mc}^{( k )} ( {m}_{v} , {m}_{h} ) = \frac{{x}_{r}^{( k )} ( {m}_{v} , {m}_{h} ) + {x}_{b}^{( k )} ( {m}_{v} , {m}_{h} ) + {x}_{g}^{( k )} ( {m}_{v} , {m}_{h} )}{3}$$

for every mᵥ and mₕ. Practitioners of ordinary skill will recognize that any color image in any color space can be converted by well-known transformations from one color space to another or into a monochromatic image. Similarly, it is recognized that the color green is the predominant component of brightness, and therefore if the image data is in the Y, U, V color space, the Y values can be used.

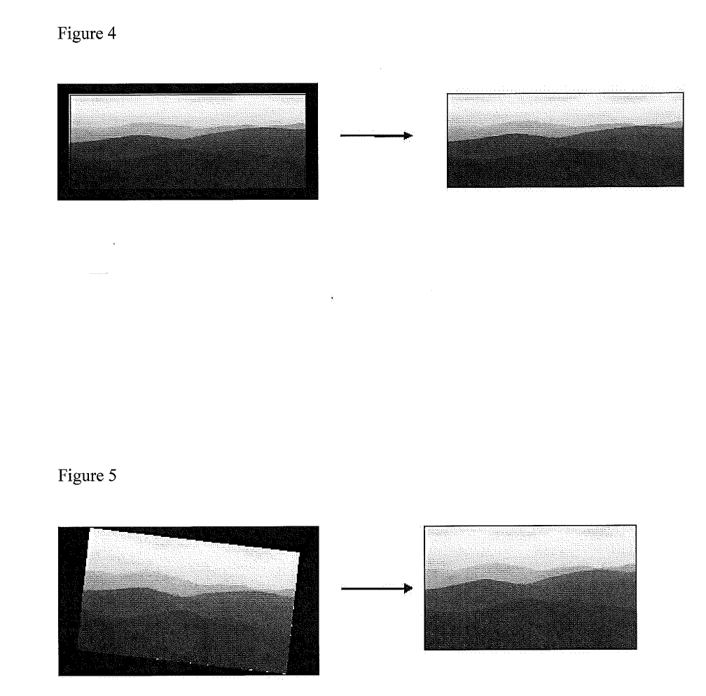

2. Dark border detection and removal: It is a usual practice to add dark borders around the frame to enhance the visibility. It is necessary to remove the dark borders before mapping the frame into a fingerprint. Since the borders are usually dark, its pixel values are very low. Thus, a threshold detection method can be used to detect the presence of the border, its location in each frame and then segment and remove the dark borders from the frame. In this case, the monochrome image of each frame is reduced in size so that the dark borders are not included in the calculation of the pattern vectors. This is show schematically on FIG. 4.
Another embodiment deals with the problem where pirated copies of a movie are made with camcorders in a movie theater environment. Oftentimes, those clips consist of irregular dark borders due to camera shakes and rotation. A rotation element is added to the detection process and a correction made to compensate for the rotation, as shows in FIG. 5. In this case, a thresholding algorithm can be used to detect a borderline that has some slope relative to the edge of the image. This slope can be converted into an angle of rotation to be applied to the image frame, using well known techniques.

3. Apply equalization to the image. The purpose of the equalization is used to equalize the distribution of the pixel values, i.e. to maximize the contrast of the image. This processing step is used to reduce the effect of illuminance (brightness), contrast and color shift resulting from the application of different video codecs or color space conversions on the pattern vector or fingerprint values.

In the preferred embodiment, root-mean-squared (RMS) equalization is used. The RMS pixel values of every frame (typically after dark borders are removed) is set to equal some predetermined constant C, in the preferred embodiment 0.5. The RMS equalization method is used (it is also called the power equalization used in the wireless communication network, see S. Verdu, “Wireless Bandwidth in the Making,” IEEE Communications Magazine, Invited Paper, Special Issue of High-Speed Wireless Access, July, 2000). The method is to calculate the RMS pixel value of a frame, say the value is K. While it is desired to have the RMS pixel value equals to C, one computes the ratio r=C/K. The ratio r is used to scale every pixel from x_{mc}^{(k)}(mₕ,mᵥ) to r·x_{mc}^{(k)}(mₕ,mᵥ) such that the RMS pixel value of the frame be equal to C. The following is the equation to compute the RMS pixel value of a given frame:

$$\sqrt{\frac{{\sum }_{{m}_{h}} {\sum }_{{m}_{v}} {( {x}_{mc}^{( k )} ( {m}_{h} , {m}_{v} ) )}^{2}}{{M}_{h}^{′} \cdot {M}_{v}^{′}}} = C$$

; where M′ₕ and M′ᵥ are the new dimensions after dark border removal.

4. After step 3, the horizontal and the vertical projection of the image is calculated as follows:
Horizontal Projection is a vector P_{H}=└P_{H}^{(k)}(0) P_{H}^{(k)}(1) . . . P_{H1}^{(k)}(M′ₕ−1)┘, where every element is a real value in the interval of (0,1). Each of the horizontal projection elements is obtained by a horizontal projection of the image, as follows:

$${P}_{H}^{( k )} ( r ) = \frac{1}{{M}_{v}} {\sum }_{{m}_{v} = 0}^{{M}_{v}^{′} - 1} {x}_{mc}^{( k )} ( {m}_{v} , r )$$

One can immediately notice that every horizontal projection element is an average of pixel values on the corresponding column of the image.
Likewise, the Vertical Projection is a vector P_{V}^{(k)}=└P_{V}^{(k)}(0) P_{V}^{(k)}(1) . . . P_{V}^{(k)}(M′ᵥ−1)┘, where

$${P}_{V}^{( k )} ( q ) = \frac{1}{{M}_{h}} {\sum }_{{m}_{h} = 0}^{{M}_{h}^{′} - 1} {x}_{mc}^{( k )} ( q , {m}_{h} )$$

Again, every vertical projection element is an average of pixel values on the corresponding row of the image.
While only one projection may not be unique, two projections—the horizontal and the vertical—are sufficiently unique to represent an image. In the preferred embodiment, the two projections are used. However, additional projections may be used as well for increased precision.

3. Each projection is compressed and converted into two fingerprints or pattern vectors.
The first fingerprint vector is the one given by the horizontal projection:

FP_{H}^{(k)}=└H^{(k)}(0)H^{(k)}(1) . . . H^{(k)}(N_{H-1})┘

where

$${H}^{( k )} ( r ) = \frac{1}{{B}_{H}} {\sum }_{s = r \cdot {O}_{H}}^{r \cdot {O}_{H} + {B}_{H}} {P}_{H}^{( k )} ( s )$$

The second fingerprint vector is the one given by the vertical projection:

FP_{V}^{(k)}=└V^{(k)}(0)V^{(k)}(1) . . . V^{(k)}(N_{V}−1)┘where

$${V}^{( k )} ( q ) = \frac{1}{{B}_{V}} {\sum }_{s = q \cdot {O}_{V}}^{q \cdot {O}_{V} + {B}_{V}} {P}_{V}^{( k )} ( s )$$

The four parameters (O_{H}, B_{H}) and (O_{V}, B_{V}) are determined by N_{H} and N_{V}, the number of fingerprint elements in the horizontal and vertical projections respectively, as well as the number of pixels in both dimensions. B is the corresponding image dimension (horizontal or vertical) divided by N and O is the value B times the percentage overlap. In the preferred embodiment, N_{H} and N_{V} are set to be 15 and the percentage overlap is 50%. Practitioners of ordinary skill will recognize that the parameters N_{H}, N_{V}, O_{H}, B_{H}, O_{V} and B_{V} and the percentage overlap can be adjusted to vary the size of the databases, the speed of operation and the accuracy of the matching.

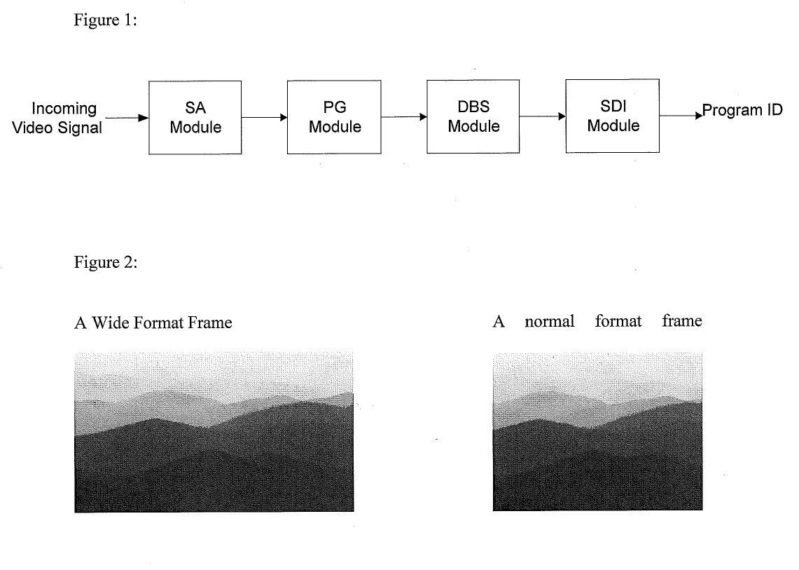

3.1. Two Fingerprint Vectors Instead of Just One:
The two fingerprint vectors, one is obtained with a horizontal projection of the image, and the other is obtained with a vertical projection of the image, are not aggregated into a single fingerprint vector. And there are good reasons for doing so.
The first reason: It is found that by separating the two projections, the recall is more robust to changes in the aspect ratio. For example, use of a wide-format clip as a source to detect the same clips in non-wide formats, and vice-versa. Note that in the example in FIG. 2, the normal format frame is obtained by a clipping of the wide format frame, which is a popular way of mapping from a wide format video to a normal format video. Due to the clipping, there is a very low chance of getting the horizontal projection matched. But the chance of getting the vertical projection matched is still reasonably good.
The second reason is to have the fingerprints be invariant to frame rotation, i.e. rotate every frame by 90 degrees to exchange the vertical and the horizontal axes. which is known to be a popular scamming scheme in order to distribute pirate video on the Internet. If the frame is rotated, then the two fingerprint vectors are interchanged. The detection algorithm can be designed easily to run parallel search on FP_{V} and FP_{H} vectors on a single database that houses both fingerprint vectors.
More over, the architecture also accommodates the effects of flipping the frames horizontally, vertically, or both. A frame is flipped horizontally means that the index mₕ is mapped to m′ₕ=M′ₕ−mₕ−1, for mₕ=0, 1, 2, . . . , M′ₕ−1. Likewise, a frame is flipped horizontally means that the index mᵥ is mapped to m′ᵥ=M′ᵥ−mᵥ−1, for mᵥ=0, 1, 2, . . . , M′ᵥ−1. Note that flipping of the frame horizontally and vertically also flip the fingerprint vectors horizontally and vertically respectively: V(p) is mapped to V(N_{V}−p−1), for p=0, 1, 2, . . . , N_{V}−1, and H(q) is mapped to H(N_{H}−q−1), for q=0, 1, 2, . . . , N_{H}−1. To accommodate the effect of flipping, the system reruns the matching search process with flipped pattern vectors.

### 3. Database Search (DBS) Module

Upon the reception of a query generated by the PG module, this module, (3), will search the database containing the sequence of pattern vectors of known programming. If a match is found, then the module returns a set of registration numbers otherwise referred to herein as program-id's and frame-id's, referred to also as frame numbers, corresponding to the identities of a set of video programs and the frame numbers within these programs where the match occurred. If the search of the database fails to find a match, the DBS Module will issue a NO-MATCH flag. It is contemplated that aspects of the invention for the DBS Module are applicable to any kind of data set containing signal signatures, even signatures derived using techniques distinct from those used in the Pattern Vector Generation module.

### 4. Program Detection and Identification (SDI) Module

This module, (4), constantly monitors the matching results from the DBS on the most recent contiguous of N time frames, as further described below. In the preferred embodiment, N is set to five, although a larger or smaller number may be used with varying results. Two schemes are used to determine if any video program has been positively detected. The first is a majority voting scheme which determines if, within each thread of matching pattern vectors among N, the number of frames that possess a valid sequence pass a designated majority of the block of frames. The second is a frame sequencing scheme which follows each of the potential thread and counts how many frames within that thread constitute a valid sequence. If there exists a thread(s) where a majority of the sequentially detected frames satisfy the frame sequencing requirement, then the program is deemed detected in that thread. Either or both schemes are used to suppress false positive detections and to increase the correct detections. In the preferred embodiment, both schemes are used.

Given a program (or more than one) that is detected, the SDI module will initiate two modes:

1. Identification mode: in this mode, the module logs all the reference information of the detected program, including title, production company or other copyright owner, or any other information input during the registration phase of the system, along with the time when the program is detected, and the time into the program that the detection was made. This information will be registered on the detection log.

2. Tracking mode: In this mode, the module tracks each detected program by monitoring if the queried result of every new frame of the detected content is obeying the sequencing requirement, described below. The algorithm is locked in this mode until the queried results cannot be matched with the sequencing requirement. Upon the exiting from the tracking mode, a number of detection attributes, including the entire duration of the tracking, and the tracking score, will be logged.

The pattern vector generated by the PG Module is sent to the DBS Module in order to conduct a search of the database for a match. The output is either a NO-MATCH flag, which indicates that the DBS fails to locate a frame within the database that passes the search criteria; or the program-id's and frame-id's of the pattern vectors that pass the search criteria.

The SDI Module collects the output from the DBS Module to detect if a new audio program is present. If so, the detected program is identified. FIG. 1 is an illustration of the flow of the algorithm from a frame of video to its result after detection. It is contemplated that aspects of the invention for the SDI Module are applicable to any kind of data set containing signal signatures, even signatures derived using techniques distinct from those used in the Pattern Vector Generation module.

### Database Search (DBS) Module

The Database Search Module takes the pattern vector of each frame from the PG Module and assembles a database query in order to match that pattern vector with database records that have the same pattern vector. A soft matching scheme is employed to determine matches between database queries and pattern vectors stored in the database.

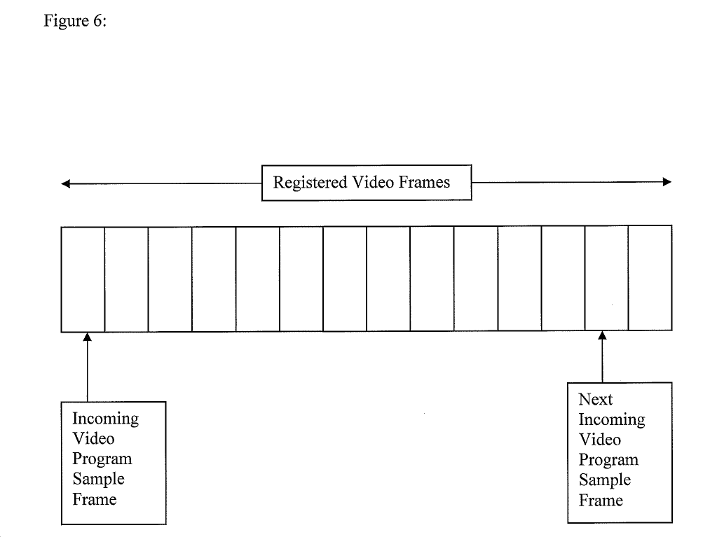

In contrast, a hard matching scheme allows at most one matching entry for each query. The soft matching scheme allows more than one matching entries per query, where a match is where a pattern vector is close enough, in the sense of meeting an error threshold, to the query vector. The number of the matching entries can either be (i). limited to some maximum amount, or (ii) limited by the maximum permissible error between the query and the database entries. Either approach may be used. The soft matching scheme relies on the fact that the program patterns are being oversampled in the registration phase. For example, as shown in FIG. 6, in the preferred embodiment the interframe distance used for registration is only 1/12 of that used in the detection. In particular, the interframe distance used for registration is 1/12 sec, and for detection/identification is 1 sec. Thus it is expected that if the m-th frame of a particular program is the best matching frame to the query, then its adjacent frames, such as (m−1)th frame and (m+1)th frame, will also be good matches. The combined effort of soft matching and sequencing schemes enhance the robustness of the detection system to video consisting of fast motions.

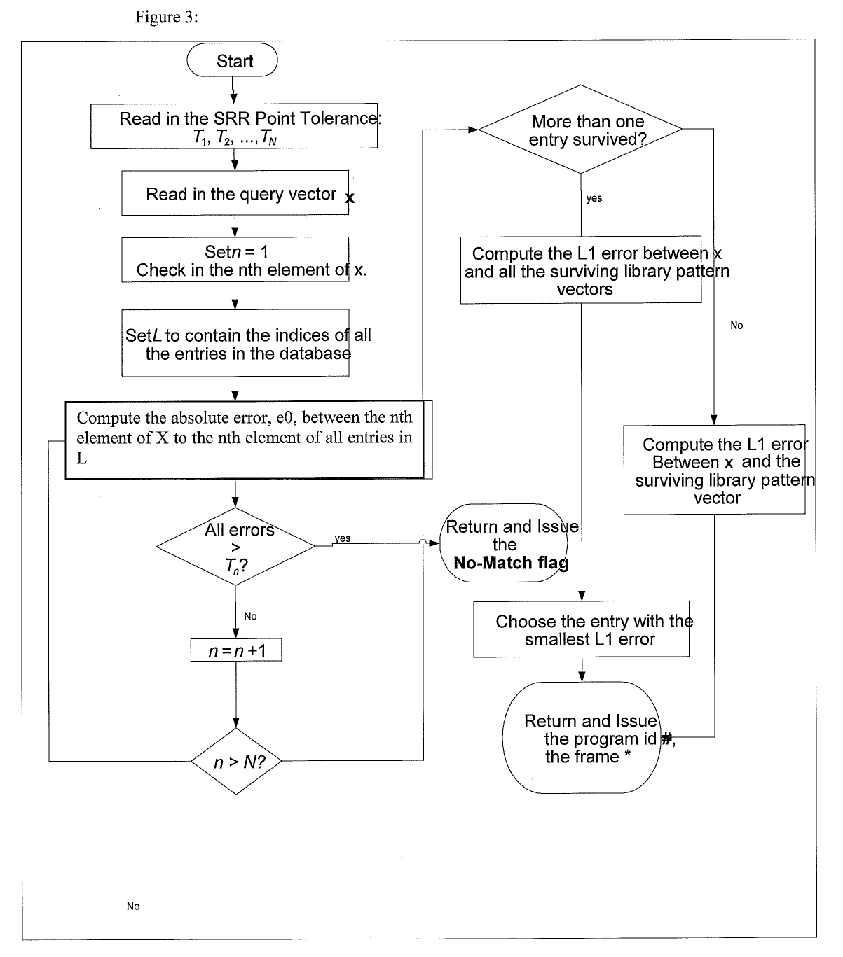

When matches are found, the corresponding program-id numbers and frame numbers in the data record is returned. The flowchart in FIG. 3 illustrates the flow in DBS Module. Practitioners of ordinary skill in the art will recognize that a search across a variable to find the location of variables that match within a given tolerance in a very large database is potentially time consuming, if done in a brute force manner. In order to address the compute time problem, a two part search is employed. In Part 1, a range search scheme select those entries within a close vicinity to the query. In Part 2 a refined search over potential candidates from Part 1 is used to select the set of candidates which are the closest neighbors to the query.

The steps are described in detail below:
1. Assemble the query from the pattern vector generated by the PG Module during the detection phase.
2. Execute a nearest neighbor search algorithm, which consists of two parts. Part 1 exercises an approximate search methodology. In particular, a range search (RS) scheme is employed to determine which entries in the database falls within a close vicinity to the query. Part 2 exercises a fine search methodology. Results from Part 1 are sorted according to their distances to the query. The search algorithm can either (i) return the best M results (in terms of having shortest distances to the query), or (ii) return all the results with distance less than some prescribed threshold. Either approach may be used. As further described below, the nearest neighbor algorithm can be replaced with other algorithms that provide better compute time performance when executing the search.
3. If there is a match, output the program-id number and the corresponding frame number. If there are multiple matches, output all program-id's and corresponding frame numbers.
   If there is no match, output the NOMATCH flag.

Range search requires pattern vectors that match within a tolerance, not necessarily a perfect match in each case. From the geometrical point of view, range search identifies which set of the entries encompassed within a polygon where the dimensions are determined by the tolerance parameters. In the preferred embodiment, the polygon is a 15 dimensional hyper-cube for each projection, i.e. both N_{V} and N_{H} are set to 15.

### Range Search (RS) Formulation

In the preferred embodiment, the pattern vector length is set. The pattern corresponding to the horizontal projection has a dimension of N_{H}, and the pattern corresponding to the vertical projection has a dimension of N_{V}. In order to explain the process, the examples below show a length of R, however, the principles apply to whatever vector length is used.

is a 1×R vector: C=[c₁ c₂ . . . c_{R}], where c is the pattern vector detected where a match is sought. In the preferred embodiment, R is equal to 15. The pattern vector library is a M×R matrix, where M is the total number of pattern vectors stored in the database and R represents the number of elements in the pattern vector. M is a potentially huge number, as demonstrated below. Assume that the entire database is represented by the matrix A:

$$A = [ \begin{matrix}{z}_{1} \\ {z}_{2} \\ ⋮ \\ {z}_{M}\end{matrix} ] = [ \begin{matrix}{z}_{1 , 1} & {z}_{1 , 2} & … & {z}_{1 , R} \\ {z}_{2 , 1} & {z}_{2 , 2} & … & {z}_{2 , E} \\ ⋮ & ⋮ & ⋱ & ⋮ \\ {z}_{M , 1} & {z}_{M , 2} & … & {z}_{M , R}\end{matrix} ]$$

Those pattern vectors stored in the library are referred to as the library pattern vector. In the preferred embodiment, each vector z is a pattern vector of R elements calculated during the registration phase with known video content for which detection is sought during the detection phase. During the detection phase, the identification exercise is to locate a set of library pattern vectors, {z_opt}, which are being enclosed within the hypercube determined by the tolerance parameter.

The search criteria can be represented as the identification of any z* such that

$${z}^{*} = {min}_{m = 1 to M} ‖ {z}_{m} - c ‖$$

In the preferred embodiment, L1 norm is used, where ∥x∥=|x₁|+|x₂|+ . . . +|x_{R}| is the L1 norm of x. Thus

$$‖ {z}_{m} - c ‖ = \underbrace{\vert {z}_{m , 1} - {c}_{1} \vert}_{{e}_{m , 1}} + \underbrace{\vert {z}_{m , 2} - {c}_{2} \vert}_{{e}_{m , 2}} + … + \underbrace{\vert {z}_{m , R} - {c}_{R} \vert}_{{e}_{m , R}}$$

Here, e_{m,n} is referred to as the nth point error between the c and zₘ.

The search for z* over the entire library with the RS algorithm is based on the satisfaction of point error criteria. That is, each point error must be less than some tolerance and, in the preferred embodiment, the L1 norm less than a certain amount. Practitioners of ordinary skill will recognize that the tolerance for each element and the L1 norm may be the same or different, which changes the efficiency of searching. The determination of the tolerance is based on some statistical measure of empirically measured errors. Further, it is recognized that other measures of error, besides a first-order L1 norm may be used. The search problem now becomes a range search problem, which is described elsewhere in the art. The following is incorporated by reference to P. K. Agarwal, Range Search, in J. E. Goodman and J. O'Rourke, editors, HANDBOOK OF DISCRETE AND COMPUTATIONAL GEOMETRY, page 575-598, Boca Raton, NY, 1997, CRC Press. C++ codes are also available from: Steve Skiena, The Algorithm Design Manual, published by Telos Pr, 1997, ISBN: 0387948600

Following are the steps in the method to determine z*:
1) Set L equal to the index set containing all the indices of library pattern vectors:

L={1,2,3, . . . , M}
2) Start with n=1.
3) Compute e_{m,n} between the nth element of c to the nth element of each z_{m,n} where m ranges from 1 to M.
4) Update L to include only those indices of pattern vectors whose nth point error is smaller than the specified tolerance Tₙ:

$$L = \{ \begin{matrix}1 \leq m \leq M , \\ where \\ {e}_{m , k} < {T}_{k , 1} \leq k \leq n\end{matrix} \}$$

Tₙ can be set arbitrarily. In the preferred embodiment Tₙ is set to be 10% of the maximum value of cₙ, i.e. if 0<cₙ<1, then Tₙ=0.1.
5) If L is now an empty set AND n≦R,
   Exit and issue the NO-MATCH FLAG.
Else: Set n=n+1.
If n>R, Go to step 6.
Else: Go to step 3.
6) Compute the error between all pattern vectors addressed in L to c:

eₘ=∥zₘ−c∥; mεL
The best solution is determined by examining all of the eₘ, and that will result with z*. Alternatively, for soft matching purposes, either of the two criteria can be used. Criteria 1: select only those zₘ with error less than some prescribed threshold eₘₐₓ. Criteria 2: select the best M candidates from L, where the M candidates are the least size of error to the Mth size of error.

Once the index m with the best L1 match is determined, the index is used to recover the data record corresponding to the pattern vector zₘ. The database module then outputs the program-id and the corresponding frame number as the output.

Note that at the start of the nth iteration, the index set L contains the indices of library pattern vectors whose point error from m=1 to n−1 passes the tolerance test. At the start of the nth iteration, the index set L is:

$$L = \{ \begin{matrix}1 \leq m \leq M , \\ where \\ {e}_{m , k} < {T}_{k} , k = 1 to n - 1\end{matrix} \}$$

The flowchart of the RS algorithm is shown in FIG. 3.

### Fast Range Search Algorithm

There is an improvement to the method that minimizes the amount of subtractions that must be performed in order to find z*. And more importantly, the execution time does not scale up as fast as the size of the database, which is especially important for database of this size. This performance enhancement is achieved at the cost of using a larger amount of memory. However, practitioners of ordinary skill will recognize that because computer memory costs have historically been reduced continuously, this is now a reasonable trade-off. The modification to the RS algorithm is to use indexing rather than computing exact error values. This modification is further explained below.

The improved search methodology for recovering the best match between a detected pattern vector and pattern vectors held in the database is referred to here as the Fast Range Search Algorithm. As before, A is the library matrix consisting of M rows of pattern vectors:

$$A = [ \begin{matrix}{z}_{1} \\ {z}_{2} \\ ⋮ \\ {z}_{M}\end{matrix} ] = [ \begin{matrix}{z}_{1 , 1} & {z}_{1 , 2} & … & {z}_{1 , R} \\ {z}_{2 , 1} & {z}_{2 , 2} & … & {z}_{2 , R} \\ ⋮ & ⋮ & ⋱ & ⋮ \\ {z}_{M , 1} & {z}_{M , 2} & … & {z}_{M , R}\end{matrix} ]$$

Each row is a particular pattern vector. There are in total M pattern vectors, and in the preferred embodiment, each has R elements.

Steps
1. Segregate each individual column of A:

$$[ \begin{matrix}{z}_{1 , 1} & {z}_{1 , 2} & … & {z}_{1 , R} \\ {z}_{2 , 1} & {z}_{2 , 2} & … & {z}_{2 , R} \\ ⋮ & ⋮ & ⋱ & ⋮ \\ {z}_{M , 1} & {z}_{M , 2} & … & {z}_{M , R}\end{matrix} ] {Segregate the columns}_{} [ \begin{matrix}{z}_{1 , 1} \\ {z}_{2 , 1} \\ ⋮ \\ {z}_{M , 1}\end{matrix} ] , \\ [ \begin{matrix}{z}_{1 , 2} \\ {z}_{2 , 2} \\ ⋮ \\ {z}_{M , 2}\end{matrix} ] , … , [ \begin{matrix}{z}_{1 , R} \\ {z}_{2 , R} \\ ⋮ \\ {z}_{M , R}\end{matrix} ]$$

2. Each of the elements in the columns are sorted in an ascending order

$$[ \begin{matrix}{z}_{1 , k} \\ {z}_{2 , k} \\ ⋮ \\ {z}_{M , k}\end{matrix} ] {Sort in Ascending order}_{} [ \begin{matrix}{\hat{z}}_{1 , k} \\ {\hat{z}}_{2 , k} \\ ⋮ \\ {\hat{z}}_{M , k}\end{matrix} ] ;$$

$${\hat{z}}_{1 , k} \leq {\hat{z}}_{2 , k} \leq … \leq {\hat{z}}_{M , k} ;$$

$$k = 1 to R$$

3. As a result of the sort, each element z_{m,k} is mapped to \hat{z}_{\hat{m},k}. Two cross indexing tables are constructed: Table Tₖ⁻¹ is a mapping of

$$m {}^{{T}_{k}^{- 1}} \hat{m}$$

and table Tₖ maps

$$\hat{m} {}^{{T}_{k}} m$$

, for every k=1 to R.

The practitioner of ordinary skill will recognize that the sorting and table creation may occur after the registration phase but prior to the search for any matches during the detection phase. By having pre-sorted the pattern vectors during the registration phase, the system reduces the search time during the detection phase. During the detection phase, the method begins with a search through the sorted vectors, as described below.

### Index Search

Given the query vector c=[c₁ c₂ . . . c_{R}] and the tolerance vector T=[T₁ T₂ . . . T_{R}], a binary search method may be used to extract the indices of those elements that fall within the tolerance. Other search methods may be used as well, but the binary search, which performs in log(M) time, is preferred.

### Steps:

1. Set k=1.
2. Exercise binary search to locate in the sorted column k: \hat{z}_{\hat{m},k},\hat{m}=1 to M, the element \hat{z}_{\hat{m}}_{_{L}}_{^{k}}_{,k} closest and more-than-or-equal-to cₖ−Tₖ. Then exercise binary search again to locate the element \hat{z}_{\hat{m}}_{_{U}}_{^{k}}_{,k} closest and less-than-or-equal-to cₖ+Tₖ. Thus, all the elements in the set {\hat{z}_{\hat{m},k},\hat{m}_{L}^{k}≦\hat{m}≦\hat{m}_{U}^{k}} satisfy the tolerance requirement. In this manner, the binary search is used twice in every kth column to locate \hat{m}_{L}^{k} and \hat{m}_{U}^{k}.
Further, let [symbol] ₖ be the index set containing the indices of all \hat{z}_{m,k} that satisfy the tolerance requirement:

[symbol]

ₖ={\hat{m}_{L}^{k}≦\hat{m}≦\hat{m}_{U}^{k}}
3. k k+1. if k>R, go to next step.

Alternatively, the process can calculate which columns have the least number of elements that pass the test, and to start with that number of elements in next step. By advancing up the sorted k values where the corresponding number of elements goes from smallest to largest, the result can converge faster than simple increment iteration over k.
4.
Repeat steps 2 and 3 until k=R in order to obtain every pair of bounds: {\hat{m}_{L}^{k},\hat{m}_{U}^{k}}, k=1 to R, and thus determine the R [symbol] ₖ's.
Each [symbol] ₖ is obtained independently. For every k, all the indices enclosed within the pair {\hat{m}_{L}^{k},\hat{m}_{U}^{k}}, k=1 to R can be converted back to the original indices using Tₖ. Then, an intersection operation is run on the R sets of indices.
An alternate way is to intersect the first two set of indices, the result is then intersected with the 3^{rd} set of indices, and so on, until the last set of indices have been intersected. This is the approached outlined below:
5. Reset k=1.
6. Retrieve all indices in [symbol] ₖ and store into the array Q.
7. Convert indices in Q to the original indices:

$$\hat{m} {}^{{T}_{k}} m$$

Store all the indices m into a set S.
Use Table Tₖ₊₁⁻¹ to convert m to \hat{m}: (thus the indices represented in column 1 are translated into their representation in column 2). Then to the results are tested to see if they are within the bound of {\hat{m}_{L}^{k+1},\hat{m}_{U}^{k+1}}.

$$m {}^{{T}_{k + 1}^{- 1}} \hat{m}$$

Apply the tolerance test and generate

R={\hat{m},\hat{m}_{L}^{k+1}≦m≦\hat{m}_{U}^{k+1}}
In this manner, each successive [symbol] ₖ would be the prior [symbol] ₖ minus those indices that failed the tolerance test for the kth element. Thus, when k=R−1 in step 6, the [symbol] _{R-1} are the indices that meet all R tolerance tests.
8. k=k+1.
9. Go to Step 6 and loop until k=R.
10. Here, the set S are all the original indices after the R intersection loops. If S is empty, issue the NO-MATCH flag. Otherwise, for hard matching, we proceed to locate the sole winner which may be the candidate with the smallest error. For soft matching, we proceed to collect all the qualifying entries.

Further speed enhancements to the fast RS algorithm

Starting from step 4, instead of starting from k=1, then k=2, then k=3, . . . , to the end, the total number of candidates in each column can be measured. The total number of candidates in each column is equal to the total number of candidates in each [symbol] ₖ. The order of k's can then be altered so that the first k is the one corresponding to the [symbol] ₖ that has the fewest candidates, the second k is the only corresponding to have the next fewest candidates, and so on. The last k is the one corresponding having the largest number of candidates of all. Thus the order of intersection starts with columns with the least number of candidates. There is no alternation to the end result except the search speed is much improved.

### D. Program Detection and Identification (SDI) Module.

The SDI module takes the results of the DBS module and then provide final confirmation of the program identity. The SDI module contains two routines:

### 1. Detection—Filtering on Regularity of the Detected Program Number:

Irregular matches, where the DBS module returns different program-id numbers on a consecutive set of frames, is a good indication that no program is being positively detected. In contrast, consistent returns, where the DBS module returns consistently the same song number on a consecutive set of frames, indicates that a program is successfully detected.

A simple algorithm based on the “majority vote rule” is used to suppress irregularity returns while detecting consistent returns. Assume that the DBS module outputs a particular program-id and frame-id for the ith frame of the detected program or song. Due to irregular returns, the result program-id will not initially be considered as a valid program identification in that frame. Instead, the system considers results on adjacent frames of i, i+1, i+2, . . . , i+2K, where in the preferred embodiment, K is set to between 2 and 4. If there is no majority winner in these (2K+1) frames, the system will issue program number=0 to indicate null detection in the ith frame, that is, no match. If there is a winner, i.e. that at least (K+1) frames that are contiguous to frame i produced the same program-id number, the system will issue for the ith frame the detected song number as such majority winning program-id number. Practitioners of ordinary skill will recognize that a majority vote calculation can be made in a number of ways, for example, it may be advantageous in certain applications to apply a stronger test, where the majority threshold is a value greater than K+1 and less than or equal to 2K+1, where a threshold of 2K+1 would constitute a unanimous vote. This reduces false positives at potentially the cost of more undetected results. For the purposes here, majority vote shall be defined to include these alternative thresholds. For computation speed, the preferred embodiment determines the majority vote using a median filter. A median on an array of 2K+1 numbers, Z=[z₁ z₂ . . . z_{2K+1}], K=1, 2, . . . , is the K-th entry after Z is sorted. For example, if Z=[1, 99, 100], the median of Z is 99. The formula for such computation is stated below:

Assume that the DBS module returns program-id #[n] for the nth frame. To calculate the median for frame i:

Let x=median([#[i] #[i+1] . . . #[i+2K]])

Then let y=1−median{[sgn(|#[i]−x|) sgn(|#[i+1]−x|) . . . sgn(|#[i+2K]−x|)]}

where

$$sgn ( x ) = ( \begin{matrix}1 & x > 0 \\ 0 & x = 0 \\ - 1 & x < 0\end{matrix}$$

Then, the detected result is a multiplication of x times y. The major feature of this formula is that it can be implemented in one pass rather than an implementation requiring loops and a counter.

### 2. Identification of Programming.

Given that an audio or video program is detected using majority rule, as explained above, the next step is to impose an additional verification test to determine if there is frame synchronization of the song being detected. In particular, the frame synchronization test checks that the frame-id number output by the DBS module for each p-th frame is a monotonically increasing function over time, that is, as p increases. If it is not, or if the frame indices are random, the detection is declared void. The following are the step-by-step method of the entire SDI

### SDI Algorithm and Steps

Let s^{p} be a structure that holds the most recent 2K+1 program_id's after the p-th broadcast frame has been detected:

$${s}^{p} = \{ \underbrace{[ \begin{matrix}{s}_{p , 1} \\ {s}_{p , 2} \\ ⋮ \\ {s}_{p , {P}_{1}}\end{matrix} ]}_{1 st bin} \underbrace{[ \begin{matrix}{s}_{p + 1 , 1} \\ {s}_{p + 1 , 2} \\ ⋮ \\ {s}_{+ 1 , {P}_{2}}\end{matrix} ]}_{2 nd bin} … \underbrace{[ \begin{matrix}{s}_{p + 2 K , 1} \\ {s}_{p + 2 K , 2} \\ ⋮ \\ {s}_{p + 2 K , {P}_{2 K + 1}}\end{matrix} ]}_{( 2 K + 1 ) th bin} \}$$

Here, s_{m,n}=the n-th program_id being detected in the m-th broadcast frame by the DBS module. Note that the Pₘ is the size of the bin. In general, Pₘ is different for different m's.

Correspondingly, f^{P} is another structure holding the corresponding frame numbers or frame indices:

$${f}^{p} = \{ \underbrace{[ \begin{matrix}{f}_{p , 1} \\ {f}_{p , 2} \\ ⋮ \\ {f}_{p , {P}_{1}}\end{matrix} ]}_{1 st bin} \underbrace{[ \begin{matrix}{f}_{p + 1 , 1} \\ {f}_{p + 1 , 2} \\ ⋮ \\ {f}_{p + 1 , {P}_{2}}\end{matrix} ]}_{2 nd bin} … \underbrace{[ \begin{matrix}{f}_{p + 2 K , 1} \\ {f}_{p + 2 K , 2} \\ ⋮ \\ {f}_{p + 2 K , {P}_{2 K + 1}}\end{matrix} ]}_{( 2 K + 1 ) th bin} \}$$

where f_{m,n}=the corresponding frame index of s_{m,n}.

Also, let SI=program_id of the last song or program that was successfully detected, such that the voting test and sequential test were successfully met. A register is created to hold this result until a new and different song or program is detected.

### Steps:

1. Compute the majority vote of s^{P}
Talking every program in the first bin of s^{P} as the reference. Scan the rest of the 2K bins to determine if any program in the first bin pass the majority vote requirement.

$${w}^{p} = \{ \begin{matrix}\{ {s}_{p , m} , m ∈ {D}_{p} \} \\ 0\end{matrix}$$

; Dₚ=Indices of entries in the first bin of s^{P} that pass the majority vote requirement
; =0 if all the program in the first bin fail the majority vote requirement

2. If w^{P}=0,
p=p+1. Go to Step 1.
Else if w^{P} is a singleton (meaning a set of one element) and not equal to zero
   Set SI=w^{P}. Go to Step 3.
Else if w^{P} has more than one candidates
   Set SI=w^{P} (case with multiple program matches). Go to Step 3.
Steps 3 to 7 are performed per s_{p,m} in w^{P}.

3. For every s_{p,m} in Dₚ, form a matrix A from the corresponding frame in f^{P}:

$$A = [ \begin{matrix}1 & {f}_{1} \\ 2 & {f}_{2} \\ ⋮ & ⋮ \\ 2 K + 1 & {f}_{2 K + 1}\end{matrix} ]$$

where f_{y} is the a frame of s_{p,m} in the t-th bin of f^{P}.
If there is no frame in the t-th bin that belongs to s_{p,m}, fₜ=0.

4. Perform the compacting of A, discarding the q-th rows in A where f_{q}=0:

$$A = [ \begin{matrix}1 & {f}_{1} \\ 2 & {f}_{2} \\ ⋮ & ⋮ \\ 2 K + 1 & {f}_{2 K + 1}\end{matrix} ] {discard the qth row if {f}_{q} = 0}_{}$$

$$B = [ \begin{matrix}{k}_{1} & {f}_{{l}_{1}} \\ {k}_{2} & {f}_{{l}_{2}} \\ ⋮ & ⋮ \\ {k}_{N} & {f}_{{l}_{N}}\end{matrix} ]$$

5. Cleanup A by removing rows, with the following steps:
A. Start with n=1.
B. Compute
d₁=fₗ_{ₙ₊₁}−fₗ_{ₙ} and d₂=kₙ₊₁−kₙ. After performing step 5 by removing all the entries with mismatched program-id's, this step identifies only those entries that follow the sequencing correctly.
C. Here, the quantity d₁ is the offset of frames between the two detected frames in B. This quantity can also be translated to an actual time offset as well: by multiplying the value by the interframe distance in samples and dividing by the samples per second. The quantity d₂ is the frame offset between the two broadcast frames. Now d is the ratio of the two offsets, representing the advance rate of the detected sequence. In particular, in the preferred embodiment, the system expects an ideal rate of 12 for video detection as the value for d. However, an elastic constraint on d is applied: If [d₁ε(12[d₂−1]+10,12[d₂−1]+14)], the two frames are in the right sequencing order. Thus, with d₂=1, an offset of 10 to 14 frames is expected between two adjacent broadcasting frames with the same program-id. If d₂=2, the offset is from 10+12 to 14+12 frames. Thus the range is the same except for an additional offset of 12 frames in the range. The values of 10 and 14 are a range centering around the ideal value 12. A range instead of a single value allows the offset to be a bit elastic rather than rigid. To be less elastic, one can choose the range to be from 11 to 13. In the same way, the range can be from 8 to 16 to be very elastic. Go to Step D.
Otherwise,
   n=n+1, in order to sequence through all the entries in B
   If n<N,
      Go to Step C.
   Otherwise,
      Go to Step D.
D. The matrix C is returned. Every row in C consists of the entries that satisfy the sequencing requirement.
Compact B by deleting rows that fail to match the sequencing requirement. Further, note that by taking the first entry of B as the reference, if the second entry fails the sequencing requirement, the process can jump to the third entry to see if it satisfies the sequencing requirement with the first entry. If the second entry is satisfied with the requirement, then the second entry becomes the reference for third entry.

$$B = [ \begin{matrix}{k}_{1} & {f}_{{l}_{1}} \\ {k}_{2} & {f}_{{l}_{2}} \\ ⋮ & ⋮ \\ {k}_{N} & {f}_{{l}_{N}}\end{matrix} ] {{->}_{sequencing requirement}}^{delete rows that fail the} C = [ \begin{matrix}{j}_{1} & {f}_{{j}_{1}} \\ {j}_{2} & {f}_{{j}_{2}} \\ ⋮ & ⋮ \\ {j}_{P} & {f}_{{j}_{P}}\end{matrix} ]$$

Majority vote requirement is enforced again here.
If the number of entries in C fails the majority vote requirement,
   the entry s_{p,m} is not qualified for further test, return to Step 3 for the next entry in Dₚ.
Otherwise,
   continue onto Step 6.
The majority vote test is applied again because even if the majority vote passes in Step 5, the majority vote test may fail after cleaning up the result with the sequencing rule requirement. If the revised majority vote passes, then a new program or song has been positively detected, otherwise, there is no detection.

6. Enter the Tracking Mode. Each thread in the Final_list will be tracked either collectively or separately.

7. Start the tracking mode:
A. Create a small database used for the tracking:
   i. In the collective tracking mode, the small database contains all the pattern vectors of all the qualifying entries in the Final_list.
   ii. In the separate tracking mode, dedicated database containing just the pattern vectors for each particular entry Final_list is created for that entry.
B. If tracking mode=collective tracking,
   i. p=p+1.
   ii. Run detection on the (p+1)th frame of broadcast.
   iii. Update the sequence of each thread. Monitor the merit of each thread by observing if the thread is satisfied with the sequencing requirement.
   iv. Continue the tracking by returning to step i. if there exists at least one thread satisfying the sequencing requirement. Otherwise, exit the tracking.
   If tracking mode=separate tracking, use dedicated database for each thread for the tracking. Steps are identical to that of collective tracking.
   The sequencing requirement here is the same as what is being used in Step 5c. That is, we expect the id of the detected frame for the new broadcast frame is in a monotonic increasing manner, and the increasing amount between successive frame of broadcast is between 10 to 12 in the preferred embodiment.
   If for any thread being tracked, that the new broadcast failed the sequencing requirement relative to the previous frame, a tolerance policy is implemented. That is, each track can have at most Q times of failure, where Q=0, 1, 2, . . . . If Q=0, there is no tolerance on failing the sequencing requirement.
C. After the tracking mode is terminated. Exam the merit of each thread. The thread that has the highest score is the winner of all in the Final_list.
   i. The score can be calculated based on the error between each frame in the thread to the corresponding frame of the broadcast; or based on the duration of the thread. Or both. In our preferred embodiment, the duration is taken as the tracking score of each of thread. The one that endures the longest within the period of tracking is the winner thread.
D. If multiple programs in being posted SI in Step 2. correct the posting by the program_id of the winning thread.

8. Wait for the new p-th frame from the broadcast, Go back to Step 1.

Practioners of ordinary skill will recognize that the values used in Step 5 for testing the sequentiality frame-id's may be changed either to make the test easier or make the test harder to meet. This controls whether the results increase false positives or suppress false positives while raising or lowering the number of correct identifications as compared to no detections.

Practitioners of ordinary skill will recognize that the detection phase of the process by means of video pattern vector matching process can first check a match using the vertical pattern vector and then attempt a match using a horizontal pattern vector. If a soft match is found with either one, then the sequential testing is applied using horizontal vectors or vertical vectors, depending on which type created the match. The assumption is that the video signal will not be rotated back and forth by 90 degrees each frame.

The invention, embodied by a computer program stored on a disk as part of a computer, can be executed by a computer that loads the program. The computer can be a server operatively connected to a database over a computer network, and also connected to the Internet. The server can use well known protocols to test websites for the presence of hyperlinks or other indicia of network addressing that have video data made available, either as download or in streamed form. The invention can receive this video data and process it in accordance with the methodology described herein. Practitioners will recognize that a video program may be registered in one format and then detected in another. For example, a website may host a streamed version at low resolution of the same video registered with the database in the system at a high resolution. The pattern vectors are optimally configured so that pattern vector calculations from the two formats produce sufficiently identical pattern vectors.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

The spirit and scope of the present invention are to be limited only by the terms of the appended claims. It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The spirit and scope of the present invention are to be limited only by the terms of the appended claims. It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

What is claimed:

1. A method of determining the identity of incoming video programming comprising:
Calculating at least one fingerprint from a first video source;
Searching a database comprised of stored fingerprints for at least one sufficiently matching fingerprint, where each such stored fingerprint is stored with accompanying data representing the identity of the video from which the stored fingerprint was derived;
Storing the identity of the video corresponding to the matching fingerprint in a file with a reference to the incoming video programming source.

2. The method of claim 1 where the calculated fingerprint is comprised of a horizontal projection of a portion of a frame of video.

3. The method of claim 1 where the calculated fingerprint is comprised of a vertical projection of a portion of a frame of video.

4. The method of claim 1 where the searching step is comprised of executing a range search of N dimensions, where N is the number of numeric elements comprising the calculated fingerprint.

5. The method of claim 1 where the range search determines which stored fingerprints are sufficiently similar to the calculated fingerprints within some pre-determined tolerance.

6. The method of claim 5 where the searching step further comprises determining whether out of a predetermined number of sequentially calculated fingerprints, a majority of the sequentially calculated fingerprints meet the tolerance requirement.

7. The method of claim 4 where the range search is conducted using a fast range search method.

8. The method of claim 1 further comprising removing substantially all of the dark border region pixels of all of the incoming video programming frames.

9. The method of claim 1 further comprising rotating to substantially a rectilinear position relative to the edges of the frames substantially all of the incoming video programming frames.

10. The method of claim 1 further comprising equalizing the pixel values of the frames of incoming video programming.

11. The method of claim 1 further comprising maintaining at least one thread of candidate matching programming and pruning any candidate thread if the series of matching frames in that candidate thread stop matching while other candidate matching threads continue to match.

12. A system that executes the method of claims 1-11.

13. A computer data storage device comprised of program data, that when executed by a computer, executes any of the methods claimed in claims 1-11.

14. A method of detecting unauthorized video programming distribution comprising:
Retrieving from a website at least one frame of incoming video programming;
Calculating at least one fingerprint out of the incoming video programming;
Searching a database of known stored video programming fingerprints for a sufficient match of such at least one incoming fingerprints, where such known video fingerprints are stored with a reference to the identity of the stored video programming fingerprints;
Storing in a data file the location of the website from which the incoming video programming was retrieved and the identity of the matching stored video programming.
